(19) United States
(12) Patent Application Publication
(10) Pub. No.: US 2009/0210187 A1
(43) Pub. Date: Aug. 20, 2009

(54) Testing system and its method for recognizing the number sequence

(76) Inventor: Cheng-Sung Lee, Taipei (TW)

Correspondence Address: SINORICA, LLC, 2275 Research Blvd., Suite 500, ROCKVILLE, MD, 20850, US

(21) Appl. No.: 12/068,121

(22) Filed: Feb. 1, 2008

(30) Foreign Application Priority Data
Apr. 20, 2007 (TW) 096113895

(51) Int. Cl. G06F 19/00

(52) U.S. Cl. 702/108

(57) ABSTRACT

The present invention relates to a testing system, which comprises: an electronic apparatus at least having an embedded controller, a connector and a communication interface; a microcontroller having a connection interface consisted of a second set of input signal lines that are coupled to a first set of output signal lines of the embedded controller, and a second set of output signal lines that are coupled to a first set of input signal lines of the embedded controller; and a testing program installed in the electronic apparatus for respectively sending data to the embedded controller and the microcontroller or receiving data from the embedded controller and the microcontroller. Whereby, when the testing system is being operated, the testing program controls the embedded controller and the microcontroller to recognize the number sequence of the second set of input signal lines and the second set of output signal lines. Furthermore, the present invention also provides a method for recognizing the number sequence of the data signal lines in a testing system.

### BACKGROUND OF THE INVENTION

1. Field of the Invention

The present invention relates to a testing system and a testing method thereof, and more particularly, to a testing method for recognizing the number sequence of the data signal lines in a testing system. The testing method is capable of automatically assigning the sequence number to the input/output data signal lines that are connected to the keyboard controller, such that the testing code can be input to perform the test.

2. Description of the Related Art

Generally, every key mechanism and the embedded keyboard controller (IC) need to be fully tested before a new keyboard can be shipped out from the factory. This test generally includes an electrical test and a mechanical test, and the test includes the following tests: a test to verify whether the corresponding data code sent from the keyboard controller to the electronic apparatus when each key is being pressed or released is correct or not; a test to verify the mechanical feature of each key (e.g. the key sensitivity), and a test to verify whether the three Light Emitted Diodes (LED) are normally operated. Wherein, the mechanical test is performed manually by human beings or robots and obviously it is disadvantageous in that: a. an external physical keyboard is required to perform the mechanical test, and its parts are easily worn down after being operated for a long period of time; b. the mechanical test requires the physical human operation and testing work; and c. it is not possible to recognize the abnormal operation such as the continuous operation of a single key and the malfunction of the to-be-tested key.

An application of such technique had been released in the conventional technique. For example, a conventional keyboard testing system and its testing method is disclosed in R.O.C. Patent No. 370198 “Apparatus for testing keyboard controller” applied by Winbond Electronics Corp. on Feb. 9, 1998 and published on Sep. 11, 1999. The aforementioned application provides a system for testing a keyboard controller, and the testing system comprises: a keyboard controller 30, which communicates with a testing program in an electronic apparatus through an Universal Serial Bus (USB); and a microcontroller, which communicates with the testing program in the electronic apparatus through a RS-232 interface, wherein the microcontroller at least comprises: a signal line coupled to the keyboard controller, a first set of signal lines and a second set of signal lines, in which the first set of signal lines send scanning data of the keyboard controller to the microcontroller, then the microcontroller receives the scanning data and sends corresponding data based on the to-be-simulated key position to the keyboard controller through the second set of signal lines, and finally the keyboard controller recognizes the key position by comparing the scanning data with the corresponding data. However, the aforementioned application only discloses the technique of the backend automatic test but lacks the description of how to make the microcontroller automatically recognize the number sequence of the input/output signal lines, thus a further improved technique is required.

### SUMMARY OF THE INVENTION

Therefore, it is an objective of the present invention to provide a testing system and a method for recognizing the number sequence of the data signal lines in the testing system. The present invention automatically recognizes the sequence number of the data signal lines, such that the testing procedure is simplified, the testing efficiency is improved, and human error is avoided.

It is another objective of the present invention to provide a testing system and a method for recognizing the number sequence of the data signal lines in the testing system. The present invention automatically assigns the sequence number to the input/output data signal lines that are connected to the keyboard controller, such that the testing code can be input to perform the test.

To achieve the foregoing objectives, the present invention provides a testing system, which comprises: an electronic apparatus at least having an embedded controller, a connector and a communication interface, in which the embedded controller comprises a first set of input signal lines and a first set of output signal lines that are coupled to the connector; a microcontroller having a connection interface consisted of a second set of input signal lines that are coupled to a first set of output signal lines of the embedded controller, and a second set of output signal lines that are coupled to a first set of input signal lines of the embedded controller; and a testing program installed in the electronic apparatus for respectively sending data to the embedded controller and the microcontroller or receiving data from the embedded controller and the microcontroller. Whereby, when the testing system is being operated, the testing program controls the embedded controller and microcontroller to recognize the number sequence of the second set of input signal lines and the second set of output signal lines.

To achieve the foregoing objectives, the present invention further provides a method for recognizing the number sequence of the data signal lines in a testing system. The testing method comprises the following steps: providing and installing a testing program in an electronic apparatus, wherein the testing program comprises a first controlling module, and the electronic apparatus has an embedded controller and a communication interface; the first controlling module sending a testing instruction to the embedded controller through the communication interface; a microcontroller sending a testing code to the embedded controller; the embedded controller converting the testing code into a corresponding key code and sending the corresponding key code to the testing program; and the testing program comparing the key code with the corresponding code of the testing code, if they match, the process is finished, otherwise the comparing operation continues.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic connection diagram of a testing system in the present invention.

FIG. 2 is a schematic detailed block diagram of a microcontroller in the present invention.

FIG. 3 is a schematic detailed block diagram of a testing program in the present invention.

FIG. 4 is a flow chart of a method for recognizing the sequence number of the data signal lines in a testing system provided by the present invention.

FIG. 5 is a detailed flow chart for a testing program to recognize the sequence number of a microcontroller's input/output signal lines in the present invention.

Appendix 1 is a general layout diagram of the key positions for a keyboard.

### DETAILED DESCRIPTION OF THE PREFERRED EMBODIMENTS

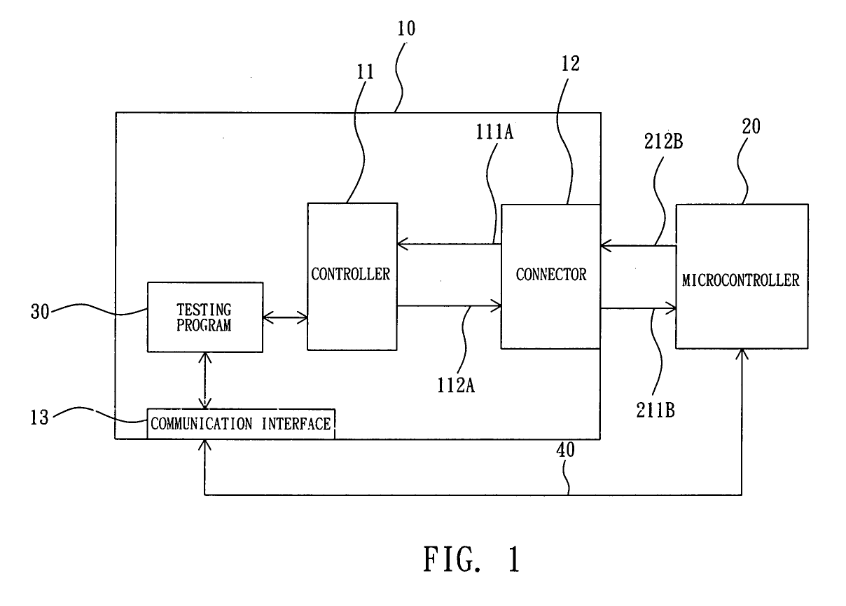

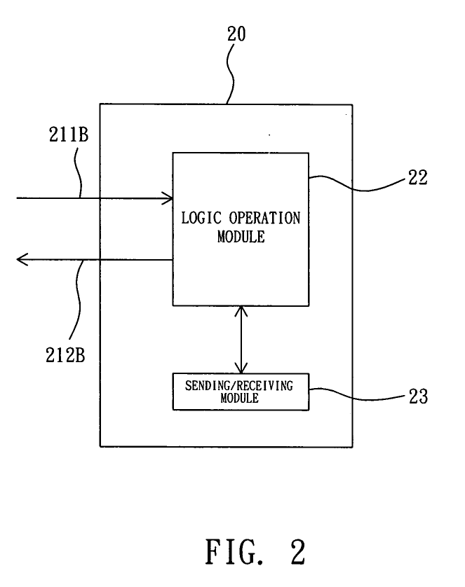

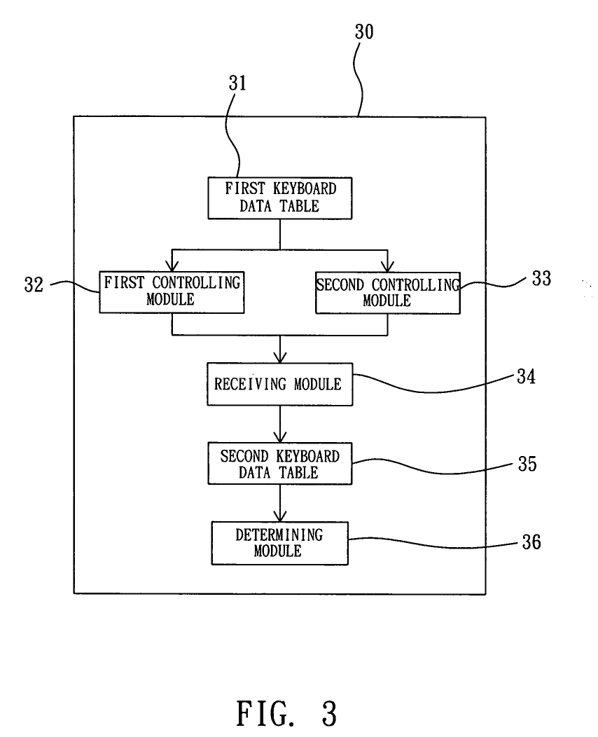

Refer to FIG. 1˜4, wherein FIG. 1 is a schematic connection diagram of a testing system in the present invention, FIG. 2 is a schematic detailed block diagram of a microcontroller in the present invention, and FIG. 3 is a schematic detailed block diagram of a testing program in the present invention.

As shown in FIG. 1, the testing system 1 of the present invention comprises an electronic apparatus 10; a microcontroller 20; and a testing program 30.

Wherein, the electronic apparatus 10 is for example, but not limited to be a desktop computer or a notebook computer, and at least comprises an embedded controller 11, a connector 12, and a communication interface 13. Wherein, the embedded controller 11 is for example, but not limited to be a keyboard controller with a first set of input signal lines 111A and a first set of output signal lines 112A that are coupled to the connector 12. The communication interface 13 is for example, but not limited to be a RS-232 communication interface.

The microcontroller 20 has a second set of input signal lines 211B and a second set of output signal lines 212B, wherein the second set of input signal lines 211B are coupled to the first set of output signal lines 112A, and the second set of output signal lines 212B are coupled to the first set of input signal lines 111A. As shown in FIG. 2, the microcontroller 20 further comprises: a logic operation module 22; and a sending/receiving module 23. Wherein, the logic operation module 22 coupled to the second set of input signal lines 211B and the second set of output signal lines 212B is responsible for the computing and determining operations by following the command from the testing program 30. The sending/receiving module 23 is coupled to the communication interface 13 through a cable 40, and the sending/receiving module 23 sends or receives data to or from the communication interface 13 through the cable 40.

Wherein, the quantity of the second set of input signal lines 211B is dependant on the quantity of the first set of output signal lines 112A and the second set of input signal lines 211B must be numbered, and the quantity of the second set of output signal lines 212B is dependant on the quantity of the first set of input signal lines 111A and the second set of output signal lines 212B must be numbered. In addition, the quantity of the second set of input signal lines 211B and the first set of output signal lines 112A is for example, but not limited to be 8˜10, and the quantity of the second set of output signal lines 212B and the first set of input signal lines 111A is for example, but not limited to be 16˜18. As shown in FIG. 1, the second set of input signal lines 211B and the second set of output signal lines 212B are respectively coupled to the connector 12 through different signal lines.

As shown in FIG. 2, the testing program 30 of the present invention further comprises: a first keyboard data table 31; a first controlling module 32, a second controlling module 33, a receiving module 34, a second keyboard data table 35; and a determining module 36.

Wherein, the coordinates of the key position on the keyboard (not shown), i.e. the column number and the row number of each key on the keyboard, is saved in the first keyboard data table 31 for issuing a command to detect the input signal and to generate the output signal. For example, the column number of the key “A” is 11111011, and the row number of the key “A” is 1111111111111101 (referring to FIG. 2); and the column number of the key “END” is 01111111, and the row number of the key “END” is 1011111111111111. Specifically, the first controlling module 32 notifies the microcontroller 20 which type of key signal should be generated next. For example, the first controlling module 32 may send a message of Column#=11111011 and Row#=1111 1111 1111 0111 to notify the microcontroller 20 to send out the key “D”. Then, the second controlling module 33 activates the embedded controller 11 to output the data mentioned above. Afterwards, the receiving module 34 receives the key code sent by the embedded controller 11. In addition, the corresponding key code data table is stored in the second keyboard data table 35. For example, the corresponding key code of the aforementioned Column#=11111011 and Row#=1111 1111 1111 0111 is 033H (referring to appendix 1, herein the code is an ASCII code). Then, the determining module 36 receives and compares the received key code to determine whether it is matched. If it matches, that indicates the sequence number of the first set of input signal lines 111A, the first set of output signal lines 112A, the second set of input signal lines 211B, and the second set of output signal lines 212B are numbered correctly. If it does not match, that indicates the sequence number of the first set of input signal lines 111A, the first set of output signal lines 112A, the second set of input signal lines 211B, and the second set of output signal lines 212B are not numbered correctly, thus it requires continuous re-tests until the sequence number is correct.

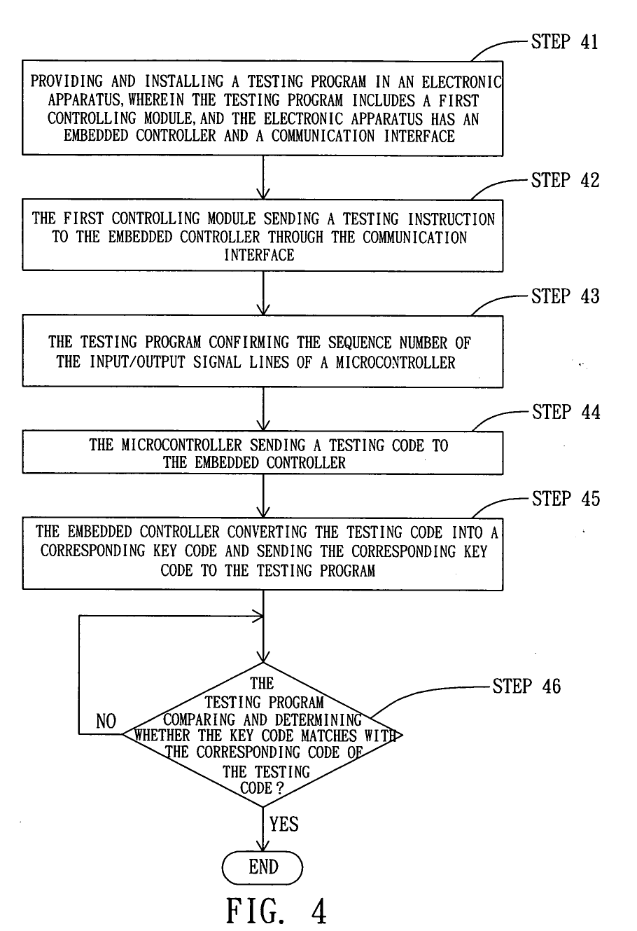

Additionally, the present invention further provides a method for recognizing the number sequence of the data signal lines in a testing system. Please refer to FIG. 4, which schematically shows a flow chart of a method for recognizing the sequence number of the data signal lines in a testing system provided by the present invention. As shown in the diagram, the method for recognizing the number sequence of the data signal lines in a testing system provided by the present invention comprises the following steps: providing and installing a testing program 30 in an electronic apparatus 10, wherein the testing program 30 includes a first controlling module 32, and the electronic apparatus 10 has an embedded controller 11 and a communication interface 13 (step 41); the first controlling module 32 sending a testing instruction to the embedded controller 11 through the communication interface 13 (step 42); the testing program 30 confirming the sequence number of the input/output signal lines of a microcontroller 20 (step 43); the microcontroller 20 sending a testing code to the embedded controller 11 (step 44); the embedded controller 11 converting the testing code into a corresponding key code and sending the corresponding key code to the testing program 30 (step 45); and the testing program 30 comparing the key code with the corresponding code of the testing code, if they match, the process is finished, otherwise the comparison continues (step 46).

Specifically, in step 41 of “providing and installing a testing program 30 in an electronic apparatus 10, wherein the testing program 30 includes a first controlling module 32, and the electronic apparatus 10 has an embedded controller 11 and a communication interface 13”, wherein the electronic apparatus 10 may be a desktop computer or a notebook computer, the communication interface 13 is for example, but not limited to be a RS-232 communication interface, and the embedded controller 11 is for example, but not limited to be a keyboard controller. In addition, the testing program 30 further comprises: a first keyboard data table 31; a first controlling module 32, a second controlling module 33, a receiving module 34, a second keyboard data table 35; and a determining module 36. Since these components were described earlier, the details are intentionally omitted herein.

In step 42, the first controlling module 32 sends a testing instruction to the embedded controller 11 through the communication interface 13.

In step 43, the testing program 30 confirms the sequence number of the input/output signal lines of the microcontroller 20, please refer to the subsequent explanation for the detailed operation.

In step 44, the microcontroller 20 sends a testing code to the embedded controller 11.

In step 45, the embedded controller 11 converts the testing code into a corresponding key code and sends the corresponding key code to the testing program 30.

In step 46, the testing program 30 compares the key code with the corresponding code of the testing code, if they match, the process is finished, otherwise the comparison continues.

The testing procedure of the testing method is as follows. First, to-be-tested electronic apparatus 10 selects a corresponding command from the first keyboard data table 31 and sends it to the microcontroller 20 through the communication interface 13. Then, the microcontroller 20 performs the relative computing and determining operations based on the received command. Specifically, the microcontroller 20 follows the received command to perform the following computation, circuit signal simulation, and mechanical operations: (a) meanwhile, the testing program 30 had confirmed the sequence number of the input/output signals of the microcontroller 20; (b) the microcontroller 20 notifies the keyboard controller 11 that the key is pressed through the second set of output signal lines 212B; (c) the keyboard controller 11 sends out the data through the first set of output signal lines 112A; (d) the microcontroller 20 compares and determines whether the data sent out by the keyboard controller 11 matches with the command of the testing program 30 or not, if it matches, the microcontroller 20 sends out the output signal data of the testing program 30; (e) if it does not match, the microcontroller 20 will do nothing, and meanwhile the keyboard controller 11 will send a second record of data to the microcontroller 20 for comparison. In addition, the keyboard controller 11 generates a corresponding key code after receiving the correct signal or data. Then, the testing program 30 receives the key code and compares and determines whether the received key code is the same as the key code stored in the first keyboard data table 31. Wherein, the whole data table related to the keyboard was already fully constructed in the testing program 30.

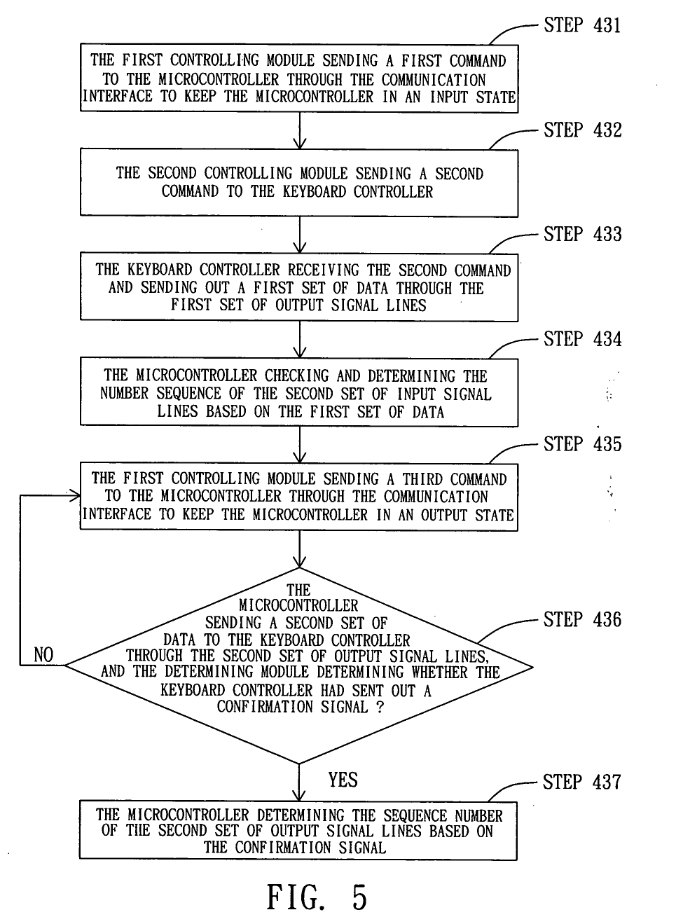

FIG. 5 is a detailed flow chart for a testing program to recognize the sequence number of a microcontroller's input/output signal lines in the present invention. As shown in the diagram, the operation performed by a testing program in the present invention to recognize the sequence number of a microcontroller's input/output signal lines further comprises the following sub steps: the first controlling module 32 sending a first command to the microcontroller 20 through the communication interface 13 to keep the microcontroller 20 in an input state (step 431); the second controlling module 33 sending a second command to the keyboard controller 11 (step 432); the keyboard controller 11 receiving the second command and sending out a first set of data through the first set of output signal lines 112A (step 433); the microcontroller 20 checking and determining the number sequence of the second set of input signal lines 211B based on the first set of data (step 434); the first controlling module 32 sending a third command to the microcontroller 20 through the communication interface 13 to keep the microcontroller 20 in an output state (step 435); the microcontroller 20 sending a second set of data to the keyboard controller 11 through the second set of output signal lines 212B, and the determining module 36 determining whether the keyboard controller 11 had sent out a confirmation signal (step 436); and the microcontroller 20 determining the sequence number of the second set of output signal lines 212B based on the confirmation signal (step 437). Wherein, if the determining module 36 determines that the keyboard controller 11 had not sent out a confirmation signal, the process goes back to step 435, otherwise, the process goes to step 437.

In step 431, the first controlling module 32 sends a first command to the microcontroller 20 through the communication interface 13 to keep the microcontroller 20 in an input state. In such state, the second set of input signal lines 211B and the second set of output signal lines 212B are both in the input state, and the read data are both equal to 1.

In step 432, the second controlling module 33 sends a second command to the keyboard controller 11, and the keyboard controller 11 starts to send out the data.

In step 433, the keyboard controller 11 receives the second command and sends out a first set of data through the first set of output signal lines 112A. Wherein, the keyboard controller 11 sequentially sends out 16˜18 records of data through the first set of output signal lines 112A, they are 0111 1111 1111 1111→1011 1111 1111 1111→1101 1111 1111 1111→ . . . →1111 1111 1111 1110 in sequence. Here, only one bit is 0 and all other bits are 1 in each record of data, such that the microcontroller 20 can easily detect and recognize it.

In step 434, the microcontroller 20 checks and determines the number sequence of the second set of input signal lines 211B based on the first set of data. Wherein, the microcontroller 20 reads the data signal sent by the keyboard controller 11 every time when the signal is changed (i.e. 1→0), and the microcontroller 20 determines the number sequence of the input signal lines based on the read signal. Therefore, after the determining. process had been repeated for 16˜18 times, the number sequence of the second set of input signal lines 211B is obtained. The testing program 30 will be notified after all of the keyboard controller's data are sequentially sent out. Meanwhile, the testing program 30 notifies the microcontroller 20 that the comparison of the second set of input signal lines 211B is completed. If the microcontroller 20 needs to re-do the confirmation, the testing program will repeat the testing steps 431˜434.

In step 435, the first controlling module 32 sends a third command to the microcontroller 20 through the communication interface 13 to keep the microcontroller 20 in an output state. Specifically, after the number sequence of the second set of input signal lines 211B of the microcontroller 20 had been confirmed, the first controlling module 32 sends a third command to the microcontroller 20 through the communication interface 13, such that the microcontroller 20 stays in the output state and is ready for recognizing the number sequence of the second set of output signal lines 212B.

In steps 436˜437, the microcontroller 20 sends a second set of data to the keyboard controller 11 through the second set of output signal lines 212B and the determining module 36 determines whether the keyboard controller 11 had sent out a confirmation signal; and the microcontroller 20 determines the sequence number of the second set output signal lines 212B based on the confirmation signal. Wherein, if the determining module 36 determines that the keyboard controller 11 had not sent out a confirmation signal yet, the process goes back to step 435, otherwise, the process goes to step 437. Specifically, the microcontroller 20 first sends a set of data 0111 1111 to the keyboard controller 11 through the second set of output signal lines 212B. Then, the keyboard controller 11 reads the data through the first set of input signal lines 111A and notifies the testing program 30 to perform the comparison process. Therefore, by performing the steps similar to the aforementioned steps, the keyboard controller 11 will read the data signal sent by the microcontroller 20 every time when the signal is changed (i.e. 1→0), and the microcontroller 20 determines the number sequence of the output signal lines 212B based on the read signal. Therefore, after the determining process had been repeated for 8 times, the number sequence of the second set of output signal lines 212B is obtained.

In summary, the testing system and method for recognizing the number sequence of the data signal lines of a testing system provided by the present invention simplifies the testing process, improves the testing efficiency and prevents human error. Furthermore, the present invention is able to automatically assign the sequence number to the input/output data signal lines that are connected to the keyboard controller, such that the testing code can be input to perform the test. Accordingly, the present invention overcomes the disadvantages of the conventional keyboard testing system and method.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A testing system, comprising:
an electronic apparatus, at least having an embedded controller, a connector, and a communication interface, wherein said embedded controller is coupled to said connector through a first set of input signal lines and a first set of output signal lines;
a microcontroller, having a connection interface and coupled to said first set of output signal lines through a second set of input signal lines and coupled to said first set of input signal lines through a second set of output signal lines; and
a testing program, installed in said electronic apparatus for respectively sending data to said embedded controller and said microcontroller or receiving data from said embedded controller and said microcontroller;
wherein, while said testing system is being operated, said testing program controls said embedded controller and said microcontroller to recognize a number sequence of said second set of input signal lines and said second set of output signal lines.

2. The testing system of claim 1, wherein said electronic apparatus is a desktop computer or a notebook computer, and said communication interface is a RS-232 communication interface.

3. The testing system of claim 1, wherein said embedded controller is a keyboard controller.

4. The testing program of claim 1, wherein said microcontroller further comprising:
a logic operation module, coupled to said second set of input signal lines and said second set of output signal lines and being responsible for computing and determining operations after receiving a command from said testing program; and
a sending/receiving module for receiving said command from said testing program and returning an operation state to said testing program.

5. The testing system of claim 1, wherein the quantity of said second set of input signal lines and said first set of output signal lines is 8˜10, and the quantity of said second set of output signal lines and said first set of input signal lines is 16˜18.

6. A method for recognizing the number sequence of the data signal lines in a testing system, comprising:
providing and installing a testing program in an electronic apparatus, wherein said testing program comprises a first controlling module, and said electronic apparatus has an embedded controller and a communication interface;
said first controlling module sending a testing instruction to said embedded controller through said communication interface;
a microcontroller sending a testing code to said embedded controller;
said embedded controller converting said testing code into a corresponding key code and sending said corresponding key code to said testing program; and
said testing program for comparing and determining whether said key code matches with said corresponding code of said testing code, if it matches, said process is finished, otherwise said comparison process continues.

7. The method for recognizing the number sequence of the data signal lines in a testing system of claim 6, wherein in said step of “providing and installing a testing program in an electronic apparatus, wherein said testing program comprises a first controlling module, and said electronic apparatus has an embedded controller and a communication interface”, wherein said electronic apparatus is a desktop computer or a notebook computer, said communication interface is a RS-232 communication interface, and said embedded controller is a keyboard controller.

8. The method for recognizing the number sequence of the data signal lines in a testing system of claim 6, wherein in said step of “providing and installing a testing program in an electronic apparatus, wherein said testing program comprises a first controlling module, and said electronic apparatus has an embedded controller and a communication interface”, wherein said first controlling module notifies said microcontroller which type of key signal should be generated next.

9. The method for recognizing the number sequence of the data signal lines in a testing system of claim 6, wherein said testing program further comprising:
a first keyboard data table for storing the coordinates of the key locations of a keyboard and for issuing a command to detect an input signal and to generate an output signal;
a second controlling module for activating said keyboard controller to output data;
a receiving module for receiving a key code output by said keyboard controller;
a second keyboard data table for storing a corresponding key code data table; and
a determining module for receiving said key code, comparing and determining whether said key code is correct.

10. The method for recognizing the number sequence of the data signal lines in a testing system of claim 6, wherein said microcontroller further comprising:
a connection interface, consisted of a second set of input signal lines coupled to said first set of output signal lines and a second set of output signal lines coupled to said first set of input signal lines;
a logic operation module, coupled to said second set of input signal lines and said second set of output signal lines and being responsible for computing and determining operations after receiving a command from said testing program; and
a sending/receiving module for receiving said command from said testing program and returning an operation state to said testing program.

11. The method for recognizing the number sequence of the data signal lines in a testing system of claim 10, wherein the quantity of said second set of input signal lines and said first set of output signal lines is 8˜10, and the quantity of said second set of output signal lines and said first set of input signal lines is 16˜18.

12. The method for recognizing the number sequence of the data signal lines in a testing system of claim 6, further comprising a step of: a testing program recognizing a number sequence of the input/output signal lines of said microcontroller, and said step is performed before a step of “said first controlling module sending a testing instruction to said embedded controller through said communication interface”.

13. The method for recognizing the number sequence of the data signal lines in a testing system of claim 12, wherein said step of “a testing program recognizing a number sequence of the input/output signal lines of said microcontroller” further comprises the following sub steps:
said first controlling module sending a first command to said microcontroller through said communication interface to keep said microcontroller in an input state;
said second controlling module sending a second command to said keyboard controller;
said keyboard controller receiving said second command and sending out a first set of data through said first set of output signal lines;
said microcontroller determining said number sequence of said second set of input signal lines based on said first set of data;
said first controlling module sending a third command to said microcontroller through said communication interface to keep said microcontroller in an output state;
said microcontroller sending a second set of data to said keyboard controller through said second set of output signal lines;
said determining module determining whether said keyboard controller had sent out a confirmation signal, if said confirmation signal had not been sent out, returning to said previous step; and
said microcontroller determining said number sequence of said second set of output signal lines based on said confirmation signal.
